(19) United States
(12) Patent Application Publication
(10) Pub. No.: US 2009/0148636 A1
(43) Pub. Date: Jun. 11, 2009

(54) MULTILAYER BAG OF PAPER

(76) Inventor: Hans-Dieter Wallat, Trebsen (DE)

Correspondence Address: WENDEROTH, LIND & PONACK, L.L.P., 1030 15th Street, N.W.,, Suite 400 East, Washington, DC, 20005-1503, US

(21) Appl. No.: 12/085,352

(22) PCT Filed: Jan. 20, 2007
(86) PCT No.: PCT/EP2007/000484

§ 371 Date: Jul. 25, 2008

(30) Foreign Application Priority Data
Jan. 26, 2006 (EP) 06001597.1

(51) Int. Cl. B32B 1/04

(52) U.S. Cl. 428/34.3

(57) ABSTRACT

Multilayer bag comprised of at least one outer and at least one inner paper layer and a synthetic layer located between an outer and an inner paper layer, characterized in that on the longitudinal side of the paper bag is provided an overlap of the outer paper web and a partial overlap of the synthetic web and the outer paper web is partially adhered to itself in the region of overlap.

The invention relates to a multilayer bag comprised of paper, which includes on its inside a film web and has improved protection of the bagged goods against moisture as well as improved venting during the filling.

To attain good moisture protection of moisture-sensitive goods, paper bags frequently comprise synthetic webs as inner layers or between two paper layers.

The synthetic web is either provided with apertures or needled or perforated to ensure adequate air permeability or venting during the filling of the bag.

EP 0 867 379 A1 discloses a perforated bag, perforation occurring through all layers of the bag. While thereby adequate air permeability is ensured, however, there is no longer any reliable protection against moisture. Such a bag, furthermore, is no longer suitable for holding bagged goods in powder form.

WO 98/57861 discloses a multilayer paper bag suitable for holding powder-form bagged materials. The paper bag here comprises, at least in the intermediate synthetic layer, perforations in band or strip form on each broad side. To ensure adequate air permeability, these perforations or apertures must have a diameter of appropriate size. However, this reduces the strength of the bag. This is especially disadvantageous when holding goods of high weight.

The invention therefore addresses the problem of providing a paper bag with improved moisture protection of the bagged goods and simultaneously having adequate air permeability or venting capability during the filling of the bag.

Subject matter of the invention is therefore a multilayer bag comprised of at least one outer and

at least one inner paper layer and, located between an outer and an inner paper layer, a layer of synthetic material, characterized in that the paper bag is provided on its longitudinal side with an overlap of the outer paper web and a partial overlap of the synthetic web and the outer paper web is partially adhered to itself in the region of overlap.

The partial adhesion of the externally disposed paper web takes place on two substantially parallel lines, and the points of adhesion can be located at the same level one next to the other or offset with respect to one another.

In a further embodiment the partial adhesion can be carried out along a line.

The spacings between the adhesion points or the spacings between the partial adhesion lines are a function of the consistency and weight of the bulk material.

The inner paper web is continuously connected, for example by adhesion, in its longitudinal region of overlap.

The discrete plies of the bag are advantageously at least partially connected with one another.

The synthetic intermediate layer in the finished bag is secured in position by simple overlapping.

As the intermediate synthetic layer can be considered, for example, synthetic films of polyolefins, such as polypropylene, polyethylene, their copolymers or mixtures.

The thickness of the intermediate synthetic layer is preferably approximately 10 to 100 μm.

In a further embodiment, instead of the synthetic intermediate layer, the outer paper layer can include a coating of a synthetic material. In this case, however, a coating-free margin strip must be provided in which the partial adhesion is carried out.

The bag can, moreover, comprise further plies, for example a further synthetic layer as an additional barrier layer. Outer and/or inner layer of paper can, moreover, be implemented such that they are multilayered. The bag according to the invention is in particular [suitable] for products requiring moisture protection, that are filled into the bag entraining large quantities of air and at high filling speed, for example via a filler nozzle.

Through the discontinuous longitudinal adhesion of the outer paper envelope, the air can escape completely still during the filling process. Thereby firmer compacted packing of most powder-form products can be attained. Examples of products filled and bagged in the bag according to the invention are, for example, cement, grout/mortar, auxiliary construction materials, chemical products, foodstuff or animal feed and the like.

The bag can be a block bottom bag, cross bottom bag, side gusseted bag or a pouch.

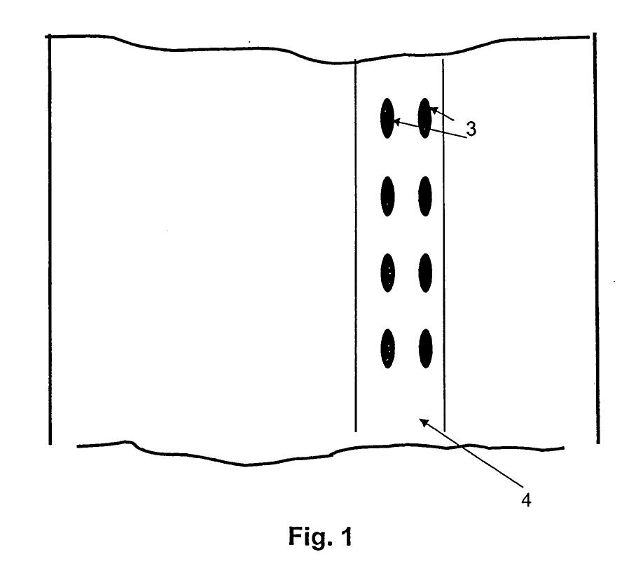

FIGS. 1 to 3 depict embodiments according to the invention of the multilayer paper bag.

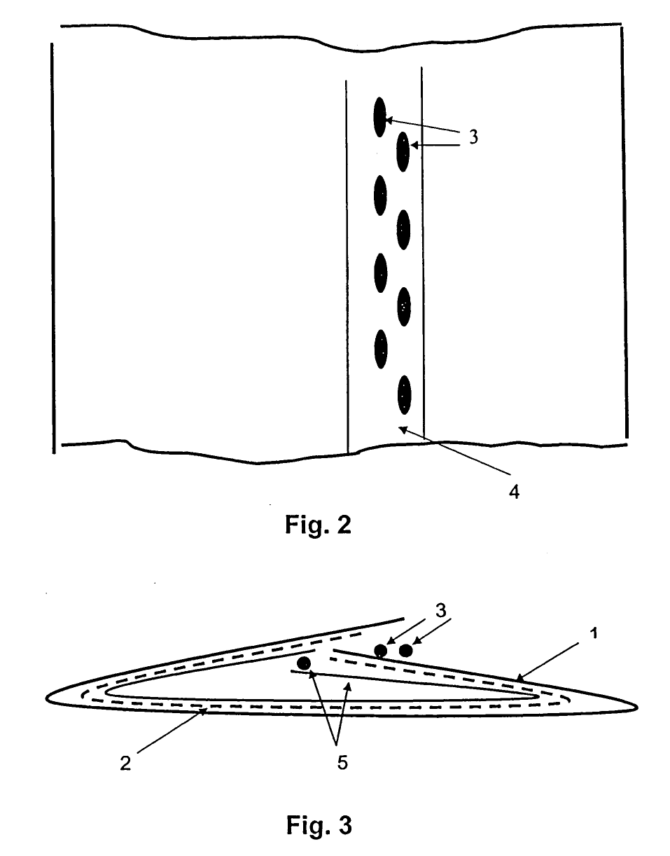

FIGS. 1 and 2 show a segment of the embodiments according to the invention of the multilayer paper bag in elevation. Depicted is the overlap of the outer layer and the discontinuous longitudinal adhesion.

FIG. 3 depicts an embodiment in cross section.

### REFERENCE NUMBERS

1: outer paper layer
2: synthetic intermediate layer (or synthetic coating of the outer paper layer)
3: discontinuous longitudinal adhesion of the outer paper layer
4: region of overlap of the outer paper layer
5: inner paper layer with longitudinal adhesion

### EXAMPLES

### Example 1

A three-layer bag comprising an external layer of paper 90 g/m² and a synthetic intermediate layer of PP 20 μm with a simple discontinuous longitudinal adhesion was produced.

The inside layer was comprised of highly porous bag paper (80 g/m²).

The bag was filled with 30 kg of adhesive plaster [of Paris] for facing.

During the filling process an adequate escape of air was observed.

During storage no moisture damage could be detected.

### Example 2

A three-layer bag comprising an external layer of paper 90 g/m² and a synthetic intermediate layer of PP 20 μm with a double parallel non-offset discontinuous longitudinal adhesion was produced.

The inside layer was comprised of highly porous bag paper (80 g/m²).

The bag was filled with 30 kg of adhesive plaster [of Paris] for facing.

During the filling process an adequate escape of air was observed.

No damage occurred upon the release of the filler nozzle.

During storage no moisture damage could be detected.

### Example 3

A three-layer bag comprising an external layer of paper 80 g/m² and a synthetic intermediate layer of PP 15 μm with a double parallel mutually offset longitudinal adhesion was produced.

The inside layer was comprised of highly porous bag paper (70 g/m²).

The bag was filled with 30 kg of adhesive plaster [of Paris] for facing.

During the filling process an adequate escape of air was observed.

No damage occurred upon the release of the filler nozzle.

During storage no moisture damage could be detected.

1) Multilayer bag comprised of at least one outer and at least one inner paper layer and a synthetic layer located between an outer and one inner paper layer, characterized in that on the longitudinal side of the paper bag is provided an overlap of the outer paper web and a partial overlap of the synthetic web and the outer paper web is partially adhered to itself in the region of overlap.

2) Multilayer bag as claimed in claim 1, characterized in that the partial adhesion is carried out in a line.

3) Multilayer bag as claimed in claim 1, characterized in that the partial adhesion is carried out in two parallel lines.

4) Multilayer bag as claimed in claim 3, characterized in that the partial adhesion points are disposed at the same level.

5) Multilayer bag as claimed in claim 3, characterized in that the partial adhesion points are disposed such that they are offset with respect to one another.
